(19) United States
(12) Patent Application Publication
(10) Pub. No.: US 2013/0082029 A1
(43) Pub. Date: Apr. 4, 2013

(54) STAMPER, IMPRINT DEVICE, PRODUCT PROCESSED BY IMPRINT DEVICE, DEVICE FOR MANUFACTURING PRODUCT PROCESSED BY IMPRINT DEVICE, AND METHOD FOR MANUFACTURING PRODUCT PROCESSED BY IMPRINT DEVICE

(71) Applicants: Tetsuhiro HATOGAI, Tokyo (JP); Kyoichi MORI, Kamisato (JP); Makoto MARUYAMA, Kamisato (JP); Akihiro MIYAUCHI, Hitachi (JP); Masahiko OGINO, Hitachi (JP)

(72) Inventors: Tetsuhiro HATOGAI, Tokyo (JP); Kyoichi MORI, Kamisato (JP); Makoto MARUYAMA, Kamisato (JP); Akihiro MIYAUCHI, Hitachi (JP); Masahiko OGINO, Hitachi (JP)

(73) Assignee: HITACHI HIGH-TECHNOLOGIES CORPORATION, Tokyo (JP)

(21) Appl. No.: 13/565,279

(22) Filed: Aug. 2, 2012

(30) Foreign Application Priority Data
Sep. 29, 2011 (JP) 2011-215000

(51) Int. Cl. B29C 59/02

(52) U.S. Cl. 216/40; 425/385; 428/156

(57) ABSTRACT

The object of the present invention is to provide a stamper or an imprint device which can reduce a variation of a base film thickness, a product processed and having a precise fine pattern, and a device for manufacturing a product processed or a method for manufacturing a product processed which can form a precise fine pattern. According to the present invention, in a stamper, an imprint device performing an imprint using the stamper, a device for manufacturing a product processed by the imprint device, a method for manufacturing a product processed by the imprint, and a product processed and manufactured, the stamper has a dummy pattern which is unnecessary for fulfilling a function of the product processed which is formed of a substrate for the product.

### BACKGROUND OF THE INVENTION

The present invention relates to a stamper according to an imprint technology, an imprint device, a product processed by an imprint device, a device for manufacturing a product processed by an imprint device, and a method for manufacturing a product processed by an imprint device and, more particularly, to a stamper, an imprint device, a device for manufacturing a product processed by an imprint device, and a method for manufacturing a product processed by an imprint device, which are capable of precisely forming patterns, and a product processed by an imprint device, in which patterns are precisely formed.

In recent years, it is expected that hard disc drives or LSIs (Large Scale Integrations) such as high-frequency devices will be manufactured in the future using patterned medias. For example, use of the hard disc drives has been increased with intention to be used for servers or computers and, moreover, has been increased for various applications, such as household hard disc recorders and AV reproduction appliances. In addition, capacities of the hard disc drives tend to be increased according to digitalization in various applications.

The increase of the capacities results in an increase in record densities of media discs. One of technologies increasing the record densities of the media discs is a patterned media. As the patterned medias, there are cited two patterned medias, namely, a discrete track media and a bit-patterned media, as shown in FIG. 2. The discrete track media (DTM) refers to a system forming concentrically circular shaped track patterns 14 on a media disc 1. The bit-patterned media refers to a system forming innumerable bit-patterns 16 as shown on the right side in the same Figure.

For the formation of patterns, a process which employs a nanoimprint technology is seen as promising. The nanoimprint technology is shown in FIG. 3. First of all, a stamper 20J which is made of, for example, quartz which allows light to be transmitted therethrough is pressed against a resist (resin) P applied onto a surface of a substrate 12 for a product processed, such as a disc substrate on which a magnetic film is formed, and performs an imprint, to thereby form an etch mask 15 (Step 1). Then, an etching process is performed using plasma gas 17, and base films BM which is produced between the stamper 20J and the processed product substrate 12 by surplus resin is removed, to thereby form a final etch mask 15 (Step 2). Then, the etch masks 15 is subjected, as a mask, to an etching (etch) process by the plasma gas 17 (Step 3), to thereby cause predetermined patterns to be finished (Step 4). Patent Literature (JP-A1 2008-12844) describes such a nanoimprint technology. Incidentally, in a case where base film thicknesses are thin, it is unnecessary to perform the removal of the base films in Step 2.

### SUMMARY OF THE INVENTION

In the nanoimprint technology, it is necessary to precisely form fine patterns. In a case where patterns are evenly disposed and a difference of a duty ratio of an uneven distribution or concavity and convexity is not present in fine patterns to be formed, as in photonic crystal patterns whose purpose is to provide a high luminance to an LED product shown in FIG. 4, it is possible to solve a problem by a technology uniformly applying a resist (resin).

However, when as shown in FIG. 5, patterns are present or absent and fine patterns are unevenly distributed, the duty ratio is varied, and sparseness occurs, a required amount of a resist for forming the patterns of the etch mask 15 is varied and variation in thicknesses BMt of the base films BM occurs (Step 1). In this case, when the patterns are present or are dense, the amount of the resist required for forming the patterns are increased and the film thicknesses of the base films BM become thin. When the patterns are absent and sparse, the required resist amount is reduced and the film thicknesses BMt of the base films BM become thick.

In the base film removing process in Step 2, the etch process is performed using the plasma gas 17, to thereby remove all the base films BM, so that the base films BM are removed with a maximum film thickness (Step 2). Consequently, processing time becomes long. If the processing time becomes long, throughput is first reduced. Secondly, overetch occurs and a height and width of each pattern is reduced as shown in Step 3.

Therefore, a first object of the present invention is to provide a stamper or imprint device which can reduce variation in base film thicknesses.

A second object of the present invention is to provide a product processed by an imprint device, which has precisely fine patterns, and a device for manufacturing a product processed by an imprint device, and a method for manufacturing a product processed by an imprint device, which can form precisely fine patterns.

In order to achieve the above-mentioned objects, the present invention has the following features.

A first feature of the present invention lies in providing a stamper which has convexly and concavely patterns on a surface thereof transfers the convexly and concavely patterns into a formation material which is applied onto a surface of a substrate of a product processed, an imprint device which, using the stamper, transfers the patterns into the formation material applied onto the surface of the substrate which finally becomes the product processed, a device and a method for manufacturing the product by etching processing using the imprint device, and a product processed, wherein the stamper includes a dummy pattern which is unnecessary for fulfilling a function of the product which is processed and made from the substrate of the product processed.

Moreover, a second feature of the present invention lies in providing the dummy pattern which is a pattern which is provided in addition to regular patterns which fulfill the function of the product processed

Moreover, a third feature of the present invention lies in providing the dummy pattern which planarly enlarges the regular patterns fulfilling the function of the product processed.

Moreover, a fourth feature of the present invention lies in providing the dummy pattern which is a pattern having a depth more than a depth required for the regular patterns fulfilling the function of the product processed.

Moreover, a fifth feature of the present invention lies in providing the product processed, which is a magnetic disc having concentrically circular shaped regular pattern having servo patterns and data on a doughnut-shaped disc, wherein the transfer is performed by transferring the dummy pattern, which is provided in addition to the regular patterns fulfilling the function of the product processed, into inside and outside regions of the doughnut-shaped disc, or into the regular pattern regions.

Moreover, a sixth feature of the present invention lies in providing the product processed, which is a SAW device that is a high frequency device, wherein the dummy pattern which is provided in addition to the regular patterns fulfilling the function of the product processed is transferred into a filter portion which the SAW has.

Moreover, a seventh feature of the present invention lies in providing the product processed, which is a SAW device that is a high frequency device, wherein the dummy pattern which planarly enlarges the regular patterns fulfilling the function of the product processed is transferred into at least one of an electrode pad portion and an earth portion which the SAW has.

According to the present invention, it is possible to provide a stamper or an imprint device which can reduce variation of a base film thickness.

Moreover, according to the present invention, it is possible to provide a product processed which has precisely fine patterns, and a device and method for manufacturing a product processed, which can manufacture a product processed which has precisely fine patterns.

### BRIEF DESCRIPTION OF THE DRAWINGS

FIG. 1 is a view showing a structure of an imprint device according to an embodiment of the present invention;

FIG. 2 is a schematic view showing an example of a patterned media;

FIG. 3 is a process view illustrating a nanoimprint process;

FIG. 4 is a view showing an example of a photonic crystal pattern whose purpose is to provide a high luminance to an LED product in which uneven distribution and a difference of a duty ratio of concavity-convexity are not present in a fine pattern;

FIG. 5 is a view explaining problems which the present invention addresses;

FIG. 6 is a view showing a fundamental concept of an embodiment 1 of the present invention;

FIG. 7 is a view illustrating a conventional magnetic disc;

FIG. 8 is a view illustrating a working example 1 in which the embodiment 1 of the present invention is applied to a magnetic disc employed as a product processed by the imprint device;

FIG. 9 is a view illustrating a typical SAW that is a high-frequency device to which the embodiment 1 of the present invention is applied;

FIG. 10 is a view illustrating a working example 2 in which the embodiment 1 of the present invention is applied to the SAW and which is an example in which linear concave and convex patterns parallel to the same direction as a direction in which a high frequency signal flows are provided as dummy patterns;

FIG. 11 is a view illustrating the working example 2 in which the embodiment 1 of the present invention is applied to the SAW and which is an example in which linear concave and convex patterns parallel to a direction perpendicular to a direction indicated by arrows in which the high frequency signal flows are provided, as the dummy patterns, at a frequency which does not adversely affect the frequency of the high frequency signal;

FIG. 12 is a view showing the working example 2 in which the embodiment 1 of the present invention is applied to the SAW and which is an example in which dot or short-line shaped concave and convex patterns are provided as the dummy patterns;

FIG. 13 is a view showing a fundamental concept of an embodiment 2 of the present invention;

FIG. 14 is a view showing a working example 4 in which the embodiment 2 of the present invention is applied to the SAW employed as the product processed;

FIG. 15 is a view illustrating an embodiment 3 of the present invention; and

FIG. 16 is a view illustrating a magnetic disc manufacturing device according to an embodiment of the present invention.

### DETAILED DESCRIPTION OF EMBODIMENTS

Embodiments of the present invention will be explained hereinafter with reference to the drawings.

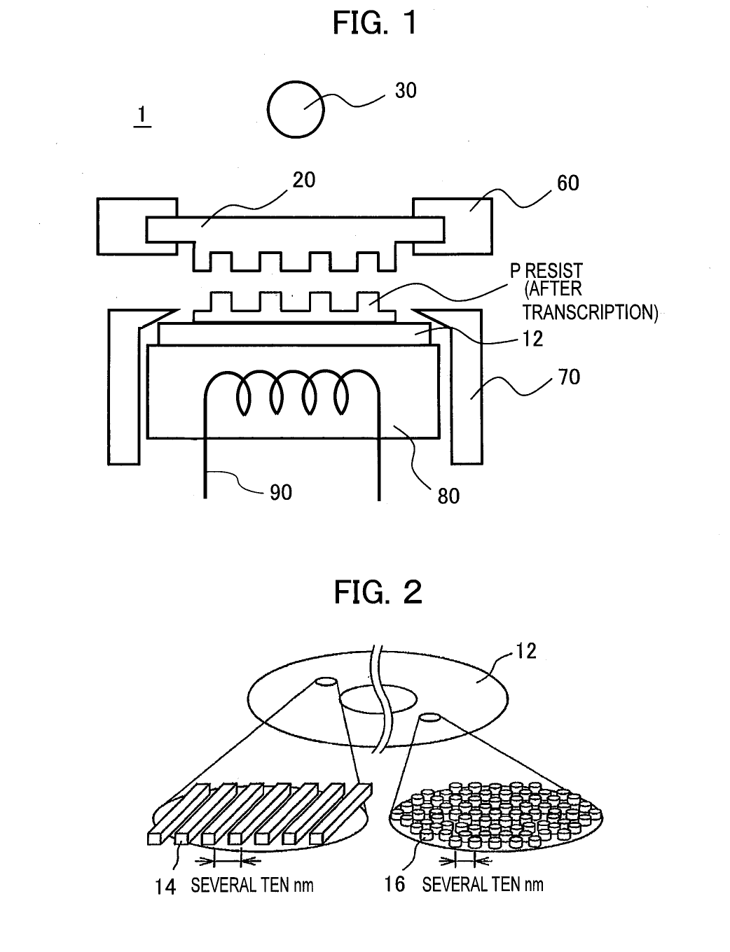

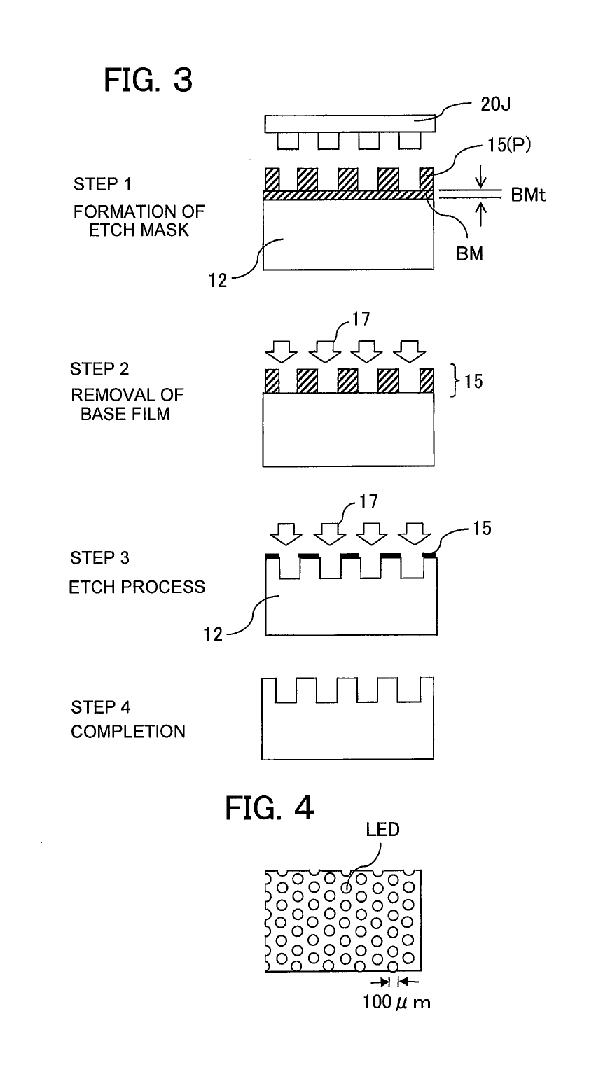

First referring to FIG. 1, a structure of an imprint device 1 according to an embodiment of the present invention will be explained. The imprint device 1 generally includes an upper section 60 of a transfer mechanism, which has constituent elements above a resist P that is a material to be formed by a stamper, a light source 30, a lower section 70 of the transfer mechanism, which has constituent elements below the resist P, and a stage 80. As the resist P, there may be employed any of a photohardening resin, a thermosetting resin and a thermoplastic material.

The transfer mechanism upper section 60 holds the stamper 20 in a flat state. The light source 30 is a UV light source that serves as an energy source to harden the photohardening resin. Moreover, if the light source 30 is used as a heat source for the thermosetting resin, it is possible to harden the thermosetting resin. Incidentally, while the imprint device 1 according to this embodiment is provided with the light source 30, the light source 30 may be configured as a device which is independent from the imprint device.

On the other hand, the transfer mechanism lower section 70 holds a substrate 12 which finally becomes a product processed by the imprint device and has the resist P on a surface thereof, into which concave and convex patterns which the stamper 20 has are to be transferred.

Moreover, the stage 80 is a base on which the substrate 12 is carried. When the stamper 20 performs transfer with respect to the resist P, the resist P receivingly stops press of the stamper, so that the resist P is formed into an intended shape on the substrate 12. Incidentally, the stage 80 is provided in an interior thereof with a heat source 90 for heating and softening the resist P that is the thermosetting resin, when the transfer is performed with respect to the resist P.

Such an imprint device transfers the patterns of the stamper 20 into the resist P to form an etch mask. Thereafter, an etching process is performed by an etching device. Incidentally, the imprint device 1 may be provided with exposure device.

Moreover, contrary to the above-mentioned structure of the imprint device 1, the transfer mechanism lower section 70 may be arranged above the resist P and the transfer mechanism upper section 60 and the light source 30 may be arranged below the resist P. Alternatively, the above-mentioned structure may be inclined at angles of 90 degrees in a right or left direction in such a manner that the transfer mechanism upper section 60 and the light source 30 are located on the right (or left) side of the resist P and the transfer mechanism lower section 70 is located on the left (or right) side of the resist P. Moreover, as far as the stamper 20 can perform the transfer with respect to the resist P, a direction in which a push is applied by the stamper 20 is not limited to a vertical or horizontal direction and may be an optionally inclined direction. Since a thickness of the applied resist material is thin, its fluidity is reduced and, even if the resist material is inclined and pressed, the resist material does not flow and a portion of the resist material which is unable to be subjected to the transfer is not produced.

A feature of the present invention lies in causing a required amount of the resist in a forming surface forming regular patterns required to fulfill a function, or the thickness of a base film, to become even. In other words, making of the required amount of the resist even is to cause a ratio to become the same between an amount of a portion of the applied resist which is used to form the regular patterns and an amount of a portion of the applied resist which is used to form the base film.

In the following explanation, patterns which have dummy portions in order that the regular patterns are formed are referred to as to “dummy patterns”. Moreover, dummy patterns which are provided on the stamper 20 are denoted by reference sign 20P. Dummy patterns on an etch mask 15 which is formed on the resist P by the dummy patterns 20P are denoted by reference sign DP.

As processes to achieve the foregoing, there are generally cited the following three processes.
(1) Embodiment 1: In addition to the regular patterns, dummy patterns are provided. In this case, the dummy patterns remain on the product processed.
(2) Embodiment 2: Dummy patterns which planarly enlarge the regular pattern are provided. In this case, the dummy patterns also remain on the product processed.
(3) Embodiment 3: Dummy patterns which make a depth of the stamper deeper than a depth required for the regular patterns are provided. In this case, the dummy patterns do not remain on the product processed.

### Embodiment 1

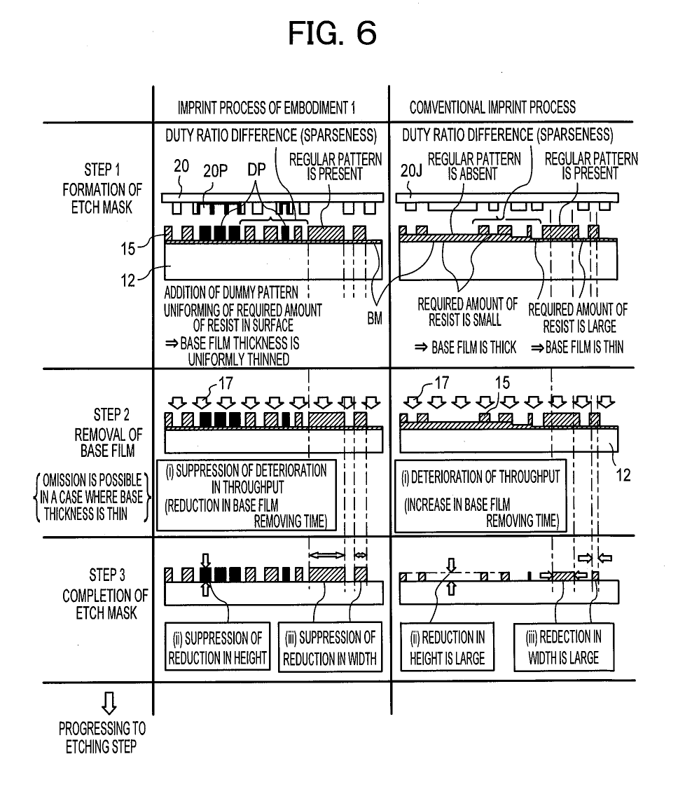

FIG. 6 is a view showing a fundamental concept of an embodiment 1 of the present invention. A right side column in FIG. 6 illustrates a conventional imprint process which is performed by a stamper 20J which has only regular patterns required for the product processed (hereinafter merely referred to as “a conventional imprint process”). A left side column in FIG. 6 illustrates an imprint process according to the embodiment 1 which is performed by a stamper 20 which has dummy patterns 20P shown in black in addition to regular patterns shown in white (hereinafter merely referred to as “an embodiment-process or working example-process”).

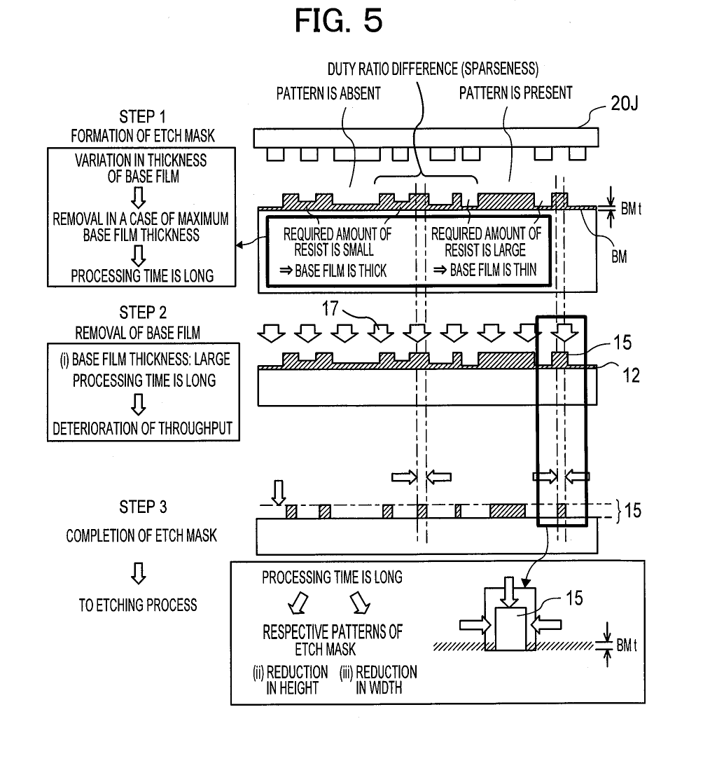

In the conventional process, as explained with reference to FIG. 5, if the patterns are present or absent, the fine pattern is unevenly distributed, the duty ratio is varied and the pattern sparseness occurs, the required amount of the resist is varied and the variation in the thickness of the base film BM occurs, as shown in the Step 2. Consequently, processing time becomes long, the throughput is reduced, overetch occurs, and the heights and widths of the respective patterns are reduced as shown in the Step 3.

On the other hand, in this embodiment-process, dummy patterns DP shown in black are provided, for example, at a region without a pattern and a sparse region with a duty ratio difference, as shown in Step 1. It can be variously contemplated what type of dummy pattern DP should be provided.

For example, in FIG. 6, patterns on the both sides of the region without a pattern are patterns having the same shape, so that dummy patterns DP having the same shape are provided at the same pitch, and the required amount of the resist is made even or a usage ratio of a mask becomes the same, to thereby make the thickness of the base film even. Moreover, since the widths of the respective regular patterns in the sparse region are different, the dummy patterns are provided in such a manner that the required amount of the resist for the sparse region becomes even or the usage ratio of the mask becomes the same. Moreover, the base film thicknesses of the both regions in a plane become as even as possible or the usage ratio of the mask becomes the same, to thereby set the width of each dummy pattern.

While FIG. 6 shows one-dimensional patterns, the sizes of the dummy patterns DP are set in such a manner that the required amount of the resist in the plane to be actually two-dimensionally imprinted becomes the same. Of course, they are not set every regions and the required amount of the resist and may be set at a time in such a manner that the required amount of the resist in the plane to be imprinted becomes the same by simulation or the like.

Next, the resist amount is determined in such a manner that the base film thickness becomes as thin as possible.

By providing the dummy patterns DP in this way, the base film is thinned as shown in the Step 2, removing time of the base film is shortened, and improvement in throughput can be realized. If the base film BM is thinned to less than a predetermined thickness, the Step 2 can be omitted.

Moreover, if the removing time of the base film BM can be shortened, an overetch amount of the etch mask which depends on the removing time is reduced, reduction in the height and width of the etch mask 15 can be suppressed and precisely fine patterns can be formed.

According to the above-explained embodiment 1, it is possible to provide a stamper or an imprint device which can reduce variation of the base film thickness.

Moreover, according to the above-explained embodiment 1, it is possible to provide a product processed and having precisely fine patterns, a device for manufacturing a product processed and having precisely fine patterns, and a method for manufacturing a product processed and having precisely fine patterns.

### Working Example 1

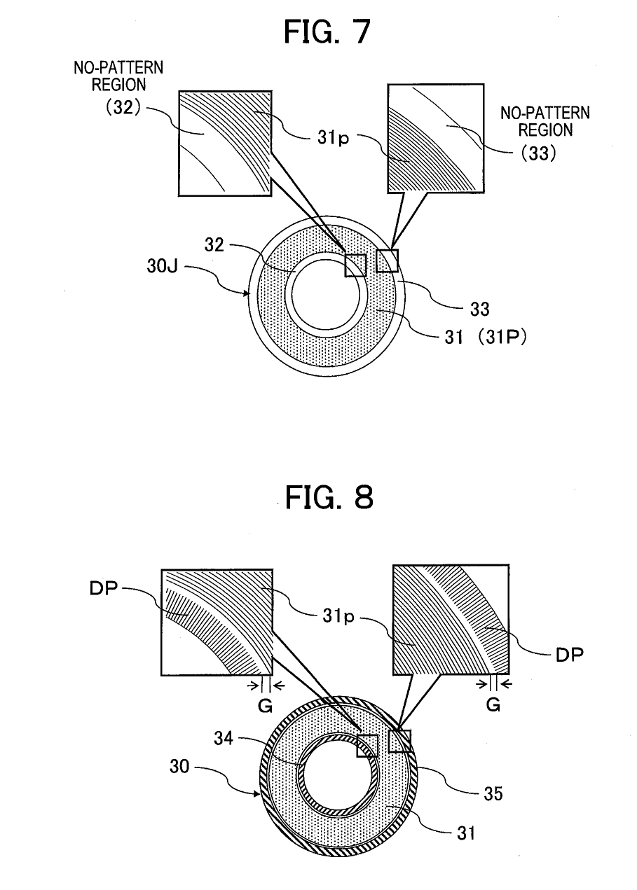

A working example 1 is an example in which this embodiment 1 is applied to a magnetic disc which is employed as the product processed. The working example is shown in FIG. 8. FIG. 7 is a view which illustrates a conventional magnetic disc 30J.

The conventional magnetic disc 30J comprises a doughnut-shaped disc, a pattern region 31 with regular patterns 31P, having servo patterns and data, which are disposed in concentrically circular form on the doughnut-shaped disc, and no-pattern regions 32, 33, without patterns, which are located inside and outside the pattern region 31 as shown in leading views. Therefore, if imprint is performed using the same resist amount as the required amount for the pattern region 31, the required amount of the resist for the no-pattern regions 32, 33 is small, so that the base film thickness becomes thick.

On the other hand, in the working example 1 shown in FIG. 8, dummy pattern regions 34, 35 which require the same required amount of the resist as the pattern region 31 do and which are shown by oblique lines are provided at the no-pattern regions 32, 33 shown in FIG. 7. As shown in leading views, this example includes dummy patterns DP disposed, via gaps G, radially with respect to concentrically circular shaped regular patterns 31P. The dummy patterns DP are not radially disposed and may be disposed in a concentrically circular form in the same manner as the regular patterns 31P are done.

The gaps G serve to definitely distinguish the regular patterns 31P and the dummy patterns DP at the time of data processing. However, data may be distinguished between the regular patterns 31P and the dummy pattern DP according to the patterns. In this case, the gaps G may not be provided.

In the above-mentioned working example 1, the dummy patterns are provided at the no-pattern regions 32, 33. However, the embodiment 1 may be applied to regions in which the fine patterns of regular patterns 31P having the servo pattern and data are unevenly distributed, or the duty ratio is varied and sparseness occurs.

### Working Example 2

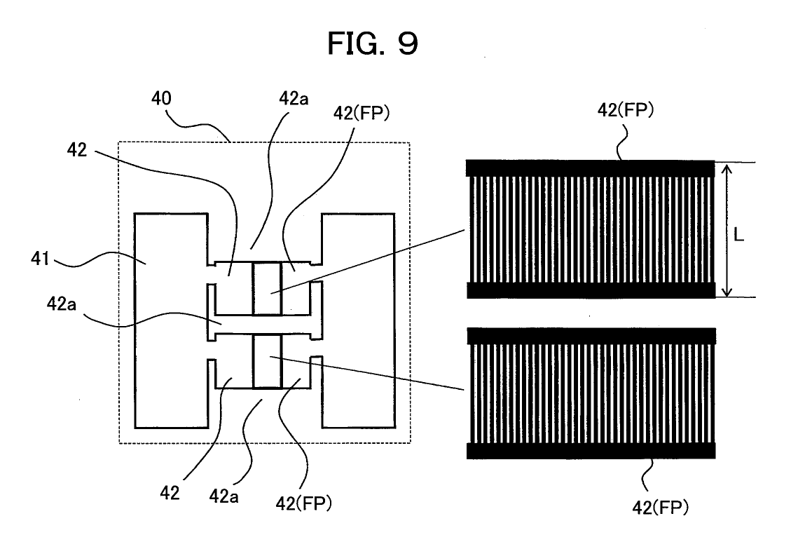

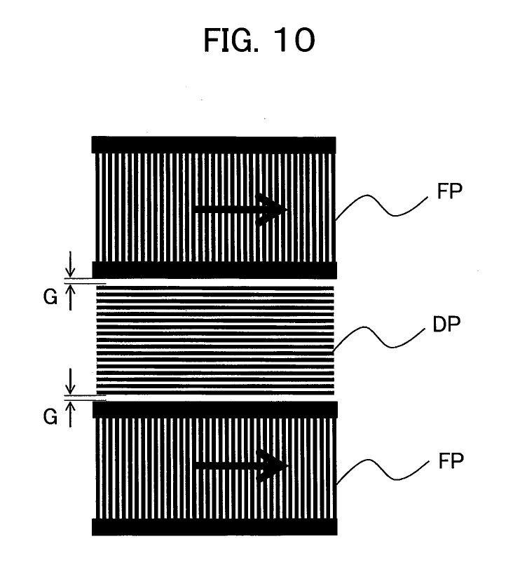

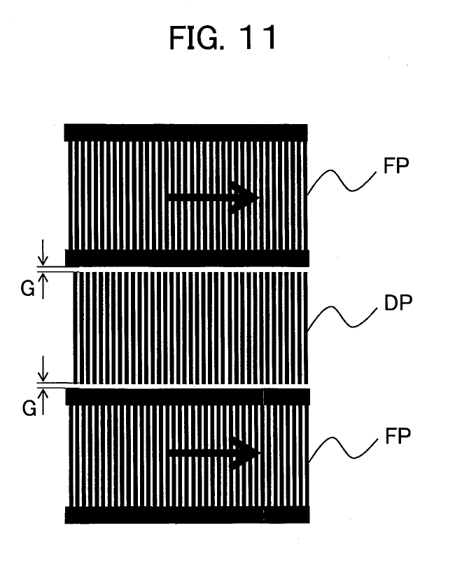

A working example 2 is an example in which the embodiment 1 is applied to a typical SAW (Surface Acoustic Wave) device 40 that is a high frequency device which is shown in FIG. 9 as a product processed. The working example is shown in FIGS. 10 to 12. The SAW device 40 includes electrode pad portions 41, filter portions 42, an earth portion (not shown), etc. The working example 2 is an example in which the embodiment 1 is applied to the filter portions 42. As shown in FIG. 9, the filter portions 42 include filter patterns FP serving as regular patterns having filter functions, and regions 42a without patterns. The filter portions 42 constitute high frequency filters based on frequency of the concavity and convexity of the filter patterns FP. The sizes L of the filter patterns FP shown in FIG. 9 are 50 μm, for example. In the no-pattern regions 42a, dummy patterns DP are provided in such a manner that they have pattern structures which do not adversely affect the filter functions and that they require the same required amount of the resist as the regions 42 (FP) with patterns require.

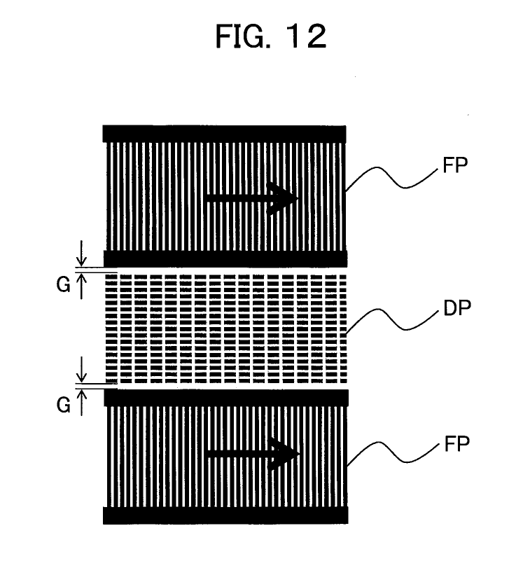

FIG. 10 shows an example in which linearly concave and convex patterns are provided as the dummy pattern DP so as to be parallel to a direction same to a direction in which high frequency signals flow as shown by arrows. FIG. 11 shows an example in which linearly concave and convex patterns which are parallel to a direction perpendicular to a direction in which high frequency signals flow as shown by arrows are provided, as the dummy patterns DP, at a frequency which does not adversely affect the frequency of the high frequency signals. FIG. 12 shows an example in which dot-shaped or short line-shaped concave and convex patterns are provided as the dummy patterns DP.

### Embodiment 2

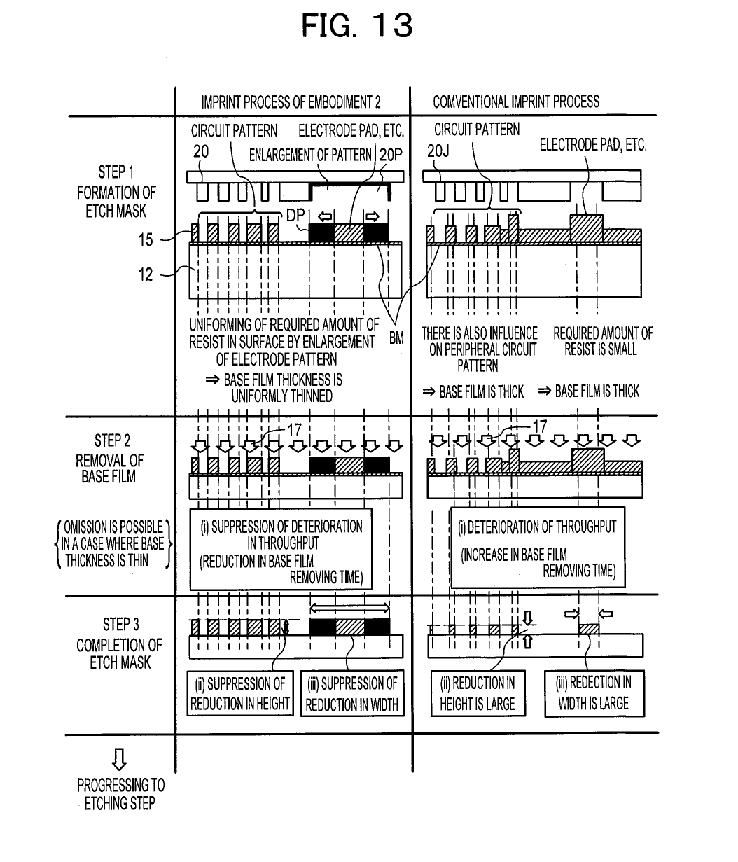

Next, referring to FIG. 13, there is illustrated a fundamental concept of an embodiment 2. For example, the SAW device 40 includes regions which are spaced apart from the filter portions 42 and have large areas which do not functionally varied even if the areas are changed in the same manner as the electrode pad portions 41 are done.

In the embodiment 2, such regions having the large areas are enlarged, the dummy patterns 20P are provided at the stamper in such a manner that the required amount of the resist becomes even or the usage ratio of the mask becomes the same, and the dummy pattern DP are made at the etch mask 15.

A right side column in FIG. 13 illustrates a conventional process which is performed by a stamper 20J for a product processed and having regular patterns which are spaced apart from the filter portions 42 and require areas large compared to other patterns such as the electrode pad portions 41 and the earth portion (not shown). Incidentally, in FIG. 13, the filter portions 42 are highlightedly shown.

A left side column in FIG. 13 illustrates an imprint process of the embodiment 2 which is performed by a stamper 20 having an enlarged dummy pattern 20P shown in a black frame in addition to the regular patterns having large areas shown in white for the electrode pad portions 41 and the earth portion (not shown) (hereinafter merely referred to as “embodiment 2-process or working example-process)

In the conventional process, if the large area portions of the electrode pad portion 41 or the earth portion (not shown) are present as shown in the left side column of FIG. 13, the resist amount to be required for mask formation is small, so that the base film BM becomes thick as shown in Step 1. Moreover, its influence is also exerted on a periphery around the spaced apart filter portions 42 and a portion in which a base film becomes thick is present. Consequently, the processing time becomes long, the throughput is reduced, overetch occurs, the heights and widths of the respective patterns are reduced as shown in Step 3.

On the other hand, in the embodiment 2-process, as shown in FIG. 13, the enlarged dummy portion shown in black is added to regular patterns shown in white in the electrode pad portions 41 or the like having the large area portions, and the enlarged dummy pattern DP is formed. Consequently, the resist amount required for formation of the etch mask 15 is made even and the base film thickness is correspondingly made even as shown in Step 1.

When the thickness of the base film BM is made even, the removing time of the base film BM is shortened and improvement in the throughput can be realized. If the thickness of the base film BM can be made less than a predetermined thickness, Step 2 can be omitted. Moreover, if the removing time of the base film BM can be shortened, an overetch amount of the etch mask which depends upon the removing time is reduced, and reduction in the height and width of the etch mask can be suppressed.

In the foregoing, a level of enlarging of the dummy pattern DP is determined, for example, by providing the dummy pattern in such a manner that the usage ratio of the resist for the mask, which is the ratio of the amount of the resist to be used for the etch mask 15 in the amount of the resist applied in order to form spaced apart circuits, becomes the same. In this case, the level is determined, while considering a mask usage ratio of the resist for other adjacent circuits

In the embodiment 2, the dummy pattern which causes the regular patterns to be enlarged is provided, whereby it is possible to provide a stamper or an imprint device which can cause the variation in the base film thickness to be reduced.

Moreover, in the embodiment 2, the dummy pattern which causes the regular patterns to be enlarged is provided, whereby it is possible to provide a product processed having a precise fine pattern, and a device and method for manufacturing a product processed which has a precise fine pattern.

### Working Example 3

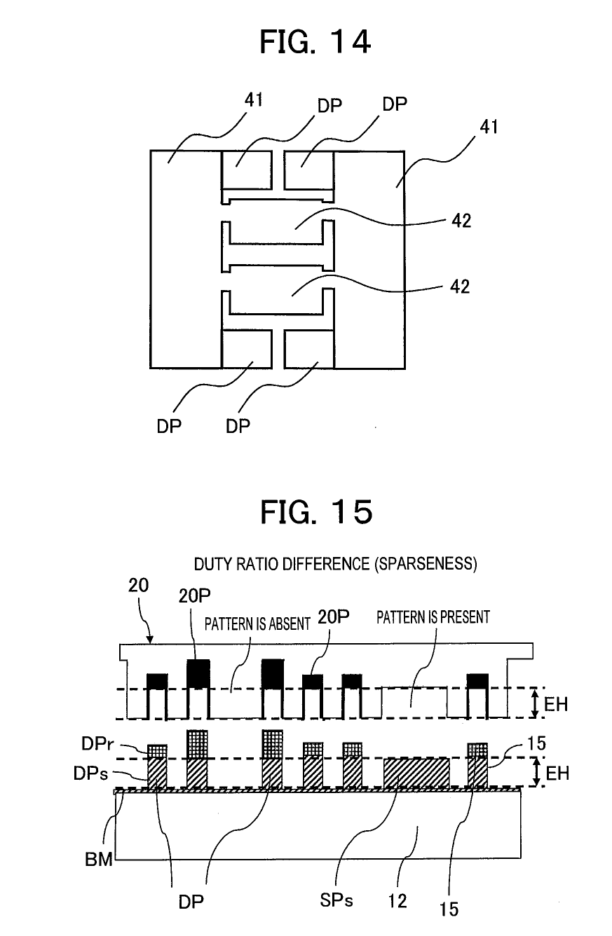

A working example 3 is an example in which the embodiment 2 is applied to the typical SAW device 40 which is the high frequency device shown in FIG. 9 as the product processed. The working example is shown in FIG. 14. FIG. 14 shows an example which has the dummy pattern DP causing the electrode pad portion 41 to be extended. The shape of the dummy pattern DP is formed in such a manner that the required resist amount is made even on the basis of the filter portion 42.

### Embodiment 3

FIG. 15 shows an embodiment 3. In the embodiments 1 and 2, the dummy pattern is provided, to thereby make the required amount of the resist even and realize to make the base film thickness even. In the embodiment 3, the dummy pattern 20P which has a depth more than the stamper forming the regular patterns are provided and extra resist can be absorbed by the pattern depth of the stamper 20, to thereby make the required amount of the resist even and realize to make the base film thickness even.

In FIG. 15, a portion of the stamper 20 which is shown by a thick frame is the dummy pattern 20P which has a dummy portion that provides the depth more than the depth required for the regular patterns and is shown in black. In this Figure, a portion having only the regular patterns SP shown in white is only one portion.

The dummy pattern of the etch mask 15 which is formed of the resist on the substrate 12 for the product processed includes a dummy portion DPr shown in a grid form and regular patterns portion SPs shown by oblique lines. If the dummy portion shown in the grid form absorbs the extra resist, the height of the dummy pattern becomes DPs.

Thus, after the base film BM is etching processed, etching process is further performed in proportion to EH. Thereafter, the remaining dummy portion DPr is cleaned and removed.

Incidentally, if the respective patterns have heights more than heights shown in FIG. 15, the extra resist can be absorbed, so that the depth is not necessarily brought to a height required for precise absorption.

In the embodiment 3, the height which allows the extra resist to be absorbed by the depths of the respective patterns of the stamper is set, whereby it is possible to provide a stamper or an imprint device which can reduce the variation in the base film thickness.

Moreover, in the embodiment 3, the dummy pattern which allows the depth of the regular patterns to be deeper is provided, whereby it is possible to provide a product processed and having precise fine patterns, and a device for manufacturing a product processed and a method for manufacturing a product processed which can provide a product processed and having precise patterns.

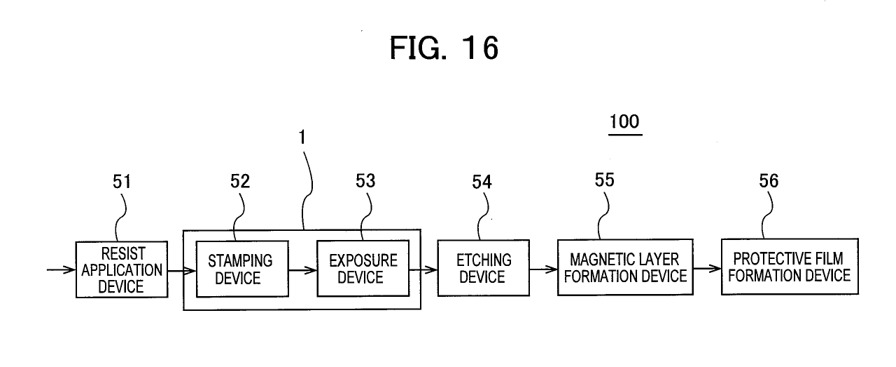

FIG. 16 is a view which shows, as an example of a device for manufacturing a product processed by the imprint, an example of a device for manufacturing a magnetic disc. Moreover, FIG. 16 is a view which illustrates a magnetic disc manufacturing device 100 in connection with patterning in a magnetic disc manufacturing line. In the magnetic disc manufacturing line, a device performing a Step of producing a disc having a magnetic layer on a glass substrate, and a device performing a Step of cleaning a surface of the disc are arranged upstream of the magnetic disc manufacturing device, and a device for forming a lubrication film is arranged downstream of the magnetic disc manufacturing device.

The magnetic disc manufacturing device 100 includes a resist application device 51 spin-coating resist onto a disc surface, an imprint device 1 including a stamping device 52 imprinting patterns onto a resist applied surface using a stamper having patterns such as servo information patterns and data tracks formed therein and an exposure device 53 performing exposure in a stamping state, an etching device 54 dryetching resist patterns as a mask and forming a groove in the disc surface, a non-magnetic layer formation device 55 causing a non-magnetic layer to be embedded in the groove, and a protective film formation device 56 forming a protective film on the disc surface.

By applying the imprint device 1 of the present invention to the magnetic disc manufacturing device explained above, the throughput of the magnetic disc manufacturing device can be improved.

According to the above-explained embodiment, it is possible to provide a magnetic disc having precise patterns, and a magnetic disc manufacturing device and a magnetic disc manufacturing method which can provide a magnetic disc having precise patterns.

While the present invention has been explained above using the magnetic disc as the product processed, the present invention can be also applied to a SAW or other product processed.

Moreover, while the present invention has been explained above using the discrete track media as the target, the present invention can be also applied to a bit-patterned media by providing dummy pattern formed by bits, or varying heights of the bits.

What is claimed is:

1. An imprint device comprising a stamper having concavely and convexly shaped patterns on a surface thereof; and an energy source hardening a formation material which is formed on a surface of a substrate of a product processed and into which the patterns of the stamper are transferred;
wherein the stamper includes a dummy pattern which is unnecessary for fulfilling a function of a product processed which is formed from the substrate of the product processed.

2. The imprint device according to claim 1, wherein the dummy pattern is a pattern which is provided in addition to regular patterns which are required for fulfilling a function of the product processed.

3. The imprint device according to claim 1, wherein the dummy pattern is a pattern which planarly enlarges regular patterns that fulfill a function of the product processed.

4. The imprint device according to claim 3, wherein the dummy pattern is a pattern which more enlarges the regular patterns having area large as compared to other regular patterns.

5. The imprint device according to claim 1, wherein the dummy pattern is a pattern which has a depth more than a depth required for regular patterns fulfilling a function of the product processed.

6. The imprint device according to claim 1, wherein the dummy pattern is provided in such a manner that a thickness of a base film, which the patterns transferred into the formation material commonly have, becomes even.

7. A device for manufacturing a product processed, comprising an application device applying a formation material onto a surface of a substrate of a product processed; the substrate finally becoming the product processed; an imprint device transferring concavely and convexly shaped patterns, which a stamper has, into the applied formation material; and an etching device etching the substrate using the transferred patterns as a mask;
wherein the stamper has a dummy pattern which is unnecessary for fulfilling a function of the product processed which is formed from the substrate.

8. The device according to claim 7, wherein the imprint device includes the stamper which has the dummy pattern provided in addition to regular patterns which fulfill a function of the product processed.

9. The device according to claim 7, wherein the imprint device includes the dummy pattern which planarly enlarges regular patterns which fulfill a function of the product processed.

10. The device according to claim 7, wherein the imprint device includes the stamper which has the dummy pattern having a depth more than a depth required for regular patterns fulfilling a function of the product processed.

11. The device according to claim 8, wherein the product processed is a magnetic disc which has concentrically circular shaped regular pattern having servo patterns and data on a doughnut-shaped disc, and wherein the imprint device transfers the dummy pattern into inside and outside regions of the doughnut-shaped disc, or into the regular pattern regions of the magnetic disc.

12. The device according to claim 8, wherein the product processed is a SAW device that is a high frequency device, and wherein the imprint device transfers the dummy pattern into a filter portion which the SAW device has.

13. The device according to claim 9, wherein the product processed is a SAW device that is a high frequency device, and wherein the imprint device transfers the dummy pattern into an electrode portion or an earth portion which the SAW device has.

14. A method for manufacturing a product processed, comprising the steps of applying a formation material onto a surface of a substrate of a product processed which finally become the product processed; transferring concave and convex patterns, which a stamper has, into the applied formation material; and etching the substrate using the transferred patterns as a mask; the transferring is performed by transferring a dummy pattern which is unnecessary for fulfilling a function of the product processed which is formed from the substrate.

15. The method according to claim 14, wherein the product processed is a magnetic disc which has concentrically circular shaped regular pattern having servo patterns and data on a doughnut-shaped disc, and wherein the transferring is performed by transferring the dummy pattern, which is provided in addition to regular patterns fulfilling a function of the product processed, into inside and outside regions of the doughnut-shaped disc, or into the regular pattern regions of the magnetic disc.

16. The method according to claim 14, wherein the product processed is a SAW device that is a high frequency device, and wherein the transferring is performed by transferring the dummy pattern, which is provided in addition to regular patterns fulfilling a function of the product processed, into a filter portion which the SAW device has.

17. The method according to claim 14, wherein the product processed is a SAW device that is a high frequency device, and wherein the transferring is performed by transferring the dummy pattern, which planarly enlarges regular patterns fulfilling a function of the product processed, into an electrode pad portion or earth portion which the SAW device has.

18. A product processed, the product being manufactured by applying a formation material onto a surface of a substrate of the product, transferring concave and convex patterns, which a stamper has, into the applied formation material, and etching the substrate using the transferred patterns as a mask;
wherein the product processed includes a dummy pattern which is unnecessary for fulfilling a function of the product processed.

19. The product according to claim 18, wherein the dummy pattern a pattern which is provided in addition to regular patterns fulfilling a function of the product processed.

20. The product according to claim 18, wherein the dummy pattern is a pattern which planarly enlarges regular patterns fulfilling a function of the product processed.

21. A stamper having concave and convex patterns on a surface thereof and transferring the concave and convex patterns into a formation material which is applied onto a surface of a substrate a product processed;
wherein the stamper includes a dummy pattern which is unnecessary for fulfilling a function of the product which is formed from the substrate.

22. The stamper according to claim 21, wherein the dummy pattern is a pattern which is provided in addition to regular patterns fulfilling a function of the product processed.

23. The stamper according to claim 21, wherein the dummy pattern is a pattern which planarly enlarges regular patterns fulfilling a function of the product processed.

24. The stamper according to claim 21, wherein the dummy pattern is a pattern which has a depth more than a depth required for regular patterns fulfilling a function of the product processed.
